(19) United States
(12) Patent Application Publication
(10) Pub. No.: US 2025/0123218 A1
(43) Pub. Date: Apr. 17, 2025

(54) PROCESSING METHOD, PROCESSING APPARATUS, AND PROCESSING SYSTEM

(71) Applicant: Lenovo (Beijing) Limited, Beijing (CN)

(72) Inventors: Yonghua LIU, Beijing (CN); Yuru JIN, Beijing (CN); Lin ZHU, Beijing (CN)

(21) Appl. No.: 18/715,031

(22) PCT Filed: Aug. 31, 2022
(86) PCT No.: PCT/CN2022/116130

§ 371 Date: Dec. 3, 2024

(30) Foreign Application Priority Data
Nov. 30, 2021 (CN) 202111452840.8

(51) Int. Cl. G01N 21/88; G01N 21/31; G01N 21/95

(52) U.S. Cl. CPC G01N 21/8851; G01N 21/31; G01N 21/95; G01N 2021/8887

(57) ABSTRACT

This disclosure provides a processing method, apparatus, and system. The method, apparatus, and system are used to perform spectral image collection on a to-be-collected object consistent of a detection object and a background object, obtain spectral characteristics of different image regions in the first spectral image, recognize attribute parameters of the to-be-collected objects corresponding to the different image regions, recognize that the attribute parameters being related to the material of the to-be-collected object, positioning and extract a second spectral image corresponding to the detection object in the first spectral image, and perform abnormality detection on the detection object based on the region characteristics of the different image regions in the second spectral image.

The disclosure claims priority to Chinese Patent Application No. 202111452840.8, titled “Processing Method, Processing Apparatus, and Processing System,” filed with the China Patent Office on Nov. 30, 2021, the entire content of which is incorporated herein by reference.

### TECHNICAL FIELD

The present disclosure generally relates to the machine visual detection field and, more particularly, to a processing method, a processing apparatus, and a processing system.

### BACKGROUND

Closing an upper cover and a lower cover of a portable terminal such as a cell phone usually uses a point glue dispensing process. After the point glue is dispensed, and before the covers are closed, the quality problems of the point glue path need to be detected. The quality problems include glue breaks, glue overflow, and residual glue from foreign matter. Many problems exist. Visual inspection by human eyes is time-consuming and low efficiency. Meanwhile, eyes are easy to have fatigue. Thus, it is very important to provide a solution based on machine vision.

### SUMMARY

The present disclosure provides the following technical solutions.

A processing method includes:
performing spectral image collection on a to-be-collected target to obtain a first spectral image;
determining spectral characteristics corresponding to different image regions in the first spectral image;
recognizing attribute parameters of to-be-collected objects corresponding to the different image regions according to the spectral characteristics corresponding to the different image regions, the attribute parameters being related to a material of the to-be-collected object, and the to-be-collected object including a detection object and a background object;
determining a target region corresponding to the detection object in the first spectral image according to the attribute parameters corresponding to the different image regions in the first spectral image, and obtaining a second spectral image formed by the target region; and
performing abnormality detection on the detection object based on region characteristics of different image regions of in the second spectral image.

In some embodiments, determining the spectral characteristics corresponding to the different image regions in the first spectral image includes:
extracting spectral information of sampling points of the different image regions in the first spectral image; and
determining reflectance of the sampling points for different wavelengths of light based on the spectral information to obtain spectral distribution characteristics of the sampling points;
wherein the spectral distribution characteristics of the sampling points corresponding to the different image regions in the first spectral image are used as the spectral characteristics of the different image regions.

In some embodiments, recognizing the attribute parameters of the to-be-collected objects corresponding to the different image regions according to the spectral characteristics corresponding to the different image regions includes:
recognizing the attribute parameters of the to-be-collected objects corresponding to the different image regions according to the spectral distribution characteristics of the sampling points corresponding to the different image regions and a first recognition rule, wherein the first recognition rule includes reflectance ranges for each wavelength of light of different wavelengths of the light corresponding to the different attribute parameters; or
processing the spectral distribution characteristics of the sampling points corresponding to the different image regions using a pre-trained first recognition model to obtain the attribute parameters of the to-be-collected objects corresponding to the different image regions.

In some embodiments, obtaining the second spectral image formed by the target image region includes:
segmenting an image of the target region from the first spectral image to obtain the second spectral image.

In some embodiments, performing abnormality detection on the detection object based on the region characteristics of the different image regions in the second spectral image includes:
extracting visual characteristics of the different image regions in the second spectral image; and
performing abnormal type recognition on detection object regions corresponding to the different image regions in the second spectral image according to the extracted visual characteristics.

In some embodiments, performing the abnormal type recognition on the detection object regions corresponding to the different image regions in the second spectral image according to the extracted visual characteristics includes:
recognizing whether the detection object regions corresponding to the different image regions in the second spectral image are abnormal and an abnormal type corresponding to an abnormal situation according to the extracted visual characteristics and a second recognition rule, wherein the second recognition rule includes reference visual characteristics corresponding to different abnormal types of the detection object; or
processing the extracted visual characteristics using a pre-trained second recognition model to obtain an abnormality recognition result, wherein the abnormality recognition result at least includes the abnormal type when the detection object regions corresponding to the different image regions are abnormal in the second spectral image.

In some embodiments, performing the abnormality detection on the detection object based on the region characteristics of the different image regions in the second spectral image includes:
extracting the spectral characteristics of the different image regions in the second spectral image; and
performing the abnormal type recognition on the detection object regions corresponding to the different image regions in the second spectral image according to the extracted spectral characteristics.

In some embodiments, performing the abnormal type recognition on the detection object regions corresponding to the different image regions in the second spectral image according to the extracted spectral characteristics includes:
identifying whether the detection object regions corresponding to the different image regions in the second spectral image are abnormal and the abnormal type corresponding to an abnormal situation according to the extracted spectral characteristics and a third recognition rule, wherein the third recognition rule includes reference spectral characteristics corresponding to different abnormal types of the detection object; or
processing the extracted spectral characteristics using a pre-trained third recognition model to obtain an abnormal recognition result, wherein the abnormal recognition result at least includes an abnormal type when the detection object regions corresponding to the different image regions in the second spectral image are abnormal.

A processing apparatus includes:
a collection module configured to perform spectral image collection on a to-be-collected target to obtain a first spectral image;
a determination module configured to determine spectral characteristics corresponding to different image regions in the first spectral image;
a recognition module configured to recognize attribute parameters of to-be-collected objects corresponding to the different image regions according to the spectral characteristics corresponding to the different image regions, the attribute parameters being related to a material of the to-be-collected object, and the to-be-collected object including a detection object and a background object;
an acquisition module configured to determine a target region corresponding to the detection object in the first spectral image according to the attribute parameters corresponding to the different image regions in the first spectral image, and obtain a second spectral image formed by the target region; and
a detection module configured to perform abnormality detection on the detection object based on region characteristics of different image regions of in the second spectral image.

A processing system includes:
a light source assembly configured to illuminate a to-be-collected object, wherein the to-be-collected object includes a detection object and a background object;
a spectral image collection assembly configured to collect a first spectral image of the to-be-collected object; and
a processing apparatus configured to perform the processing method described above to realize abnormality detection on the detection object.

Based on the above technical solutions, the processing method, processing apparatus, and processing system of the present disclosure are used to perform spectral image collection on a to-be-collected object consistent of a detection object and a background object, obtain spectral characteristics of different image regions in the first spectral image, recognize attribute parameters of the to-be-collected objects corresponding to the different image regions, recognize that the attribute parameters being related to the material of the to-be-collected object, positioning and extract a second spectral image corresponding to the detection object in the first spectral image, and perform abnormality detection on the detection object based on the region characteristics of the different image regions in the second spectral image.

### BRIEF DESCRIPTION OF THE DRAWINGS

To more clearly illustrate the technical solutions of the present disclosure or related technologies, the accompanying drawings used in the description of embodiments or the existing technologies are briefly described below. Apparently, the accompanying drawings described below are merely embodiments of the present disclosure. For those ordinary skills in the art, other accompanying drawings can also be obtained according to the provided accompanying drawings without creative efforts.

FIG. 1 illustrates a schematic flowchart of a processing method according to the present disclosure.

FIG. 2 illustrates a schematic diagram of colors of 5 channels of a series of channels included in a sampling point according to the present disclosure.

FIG. 3 illustrates a schematic diagram showing a comparison of different color channels corresponding to a grayscale image, an RGB image, a multispectral image, and a hyperspectral image according to the present disclosure.

FIG. 4 illustrates a schematic diagram showing a comparison of reflectance curves of different materials for different wavelengths of light in a multi-spectrum/hyper-spectrum according to the present disclosure.

FIG. 5 illustrates a schematic flowchart of another processing method according to the present disclosure.

FIG. 6 illustrates a schematic diagram showing three types of glue path defects of glue breaks, glue overflow, and residual glue from foreign matter according to the present disclosure.

FIG. 7 illustrates a schematic flowchart of another processing method according to the present disclosure.

FIG. 8 illustrates a schematic structural diagram of a processing apparatus according to the present disclosure.

FIG. 9 illustrates a schematic structural diagram of a processing system according to the present disclosure.

### DETAILED DESCRIPTION OF THE EMBODIMENTS

To more clearly and completely describe the technical solutions of embodiments of the present disclosure in connection with the accompanying drawings of embodiments of the present disclosure. Apparently, described embodiments are merely some embodiments of the present disclosure not all embodiments. All other embodiments obtained by those ordinary skills in the art without creative efforts are within the scope of the present disclosure.

Many quality issues of point glue path are included such as glue breaks, glue overflow, and residual glue from foreign matter. Visual inspection by human eyes is time-consuming and low efficiency. For this problem, the inventors found two possible solutions. In a 3-Dimensions (3D) solution, a laser profiler is configured to scan a circle by following a point glue machine path to collect glue path data to perform glue path abnormal detection. In another solution, a 2-Dimensions (2D)

Meanwhile, eyes are easy to have fatigue. Thus, it is very important to provide a solution based on machine vision.

Visual inspection is time-consuming and laborious, and the efficiency is low. To address this problem, the applicant has identified two possible solutions: one is to use a laser profiler to follow the dispensing machine path to scan the 3D (three-dimensional) data of the glue path for anomaly detection; the other is to use a 2D (two-dimensional) area scan camera to capture a glue path image. Then, the glue path part can be separated using an algorithm for glue path defect detection.

However, the two solutions above can include the following disadvantages.
1. Samples for glue path defects are insufficient. Both solutions require accumulating sufficient samples to train the required model, which is then used in a production line, and requires a long R&D time.
2. A slight change (which is common) in the glue path of a same type of machine results in glue path abnormality, detection precision reduction. Thus, samples need to be re-collected, and the model needs to be re-trained.
3. Different types of machines have different glue paths, which results in a large reduction in the precision of the glue path abnormality detection. Then, samples need to be re-collected, and the model needs to be re-trained.

Thus, the present disclosure provides a processing method, a processing apparatus, and a processing system to provide a solution for an abnormality detection based on the machine vision for the detection object such as the point glue path and overcome the technical defects of the above two possible solutions.

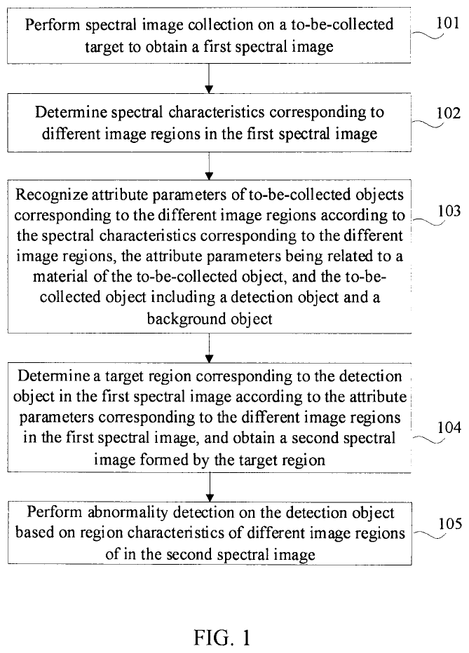

As shown in FIG. 1, a processing method of the present disclosure includes the following processes.

At 101, spectral image collection is performed on a to-be-collected object to obtain a first spectral image.

The to-be-collected object can include a detection object and a background object. The detection object and the background object can include, but are not limited to, point glue paths for closing an upper cover and a lower cover of a portable terminal such as a cell phone and a tablet and a background object of the point glue path. For example, a substrate corresponding to the point glue path at the upper cover and the lower cover of the cell phone or surrounded other objects.

The applicant finds that the detection object and the background object can have different materials, or even with the same material, attributes such as the density or thickness can be different for the detection object and the background object. Moreover, the applicant also finds that the spectral characteristics can be more easily used to differentiate the different materials or different attribute characteristics such as densities and thicknesses of the same material. Thus, the present disclosure provides a solution for differentiating the detection object and the background object according to the spectral characteristics to recognize and extract the spectral image part corresponding to the detection object from the spectral images of the detection object and the background object to perform abnormality detection on the detection object. Compared to the above two possible solutions, differentiating the detection object and the background object through the spectral characteristic, the image part corresponding to the detection object can be more accurately and rapidly recognized and extracted.

Based on the above technical ideas, for the to-be-collected object consistent of the detection object and the background object of the detection object, in step 101, the spectral image collection can be first performed on the to-be-collected object to obtain the first spectral image of the to-be-collected object.

The collection equipment can include but is not limited to the multispectral camera or a hyperspectral camera, which can be configured to perform spectral image collection on the to-be-collected object. In practical applications, a predetermined light source assembly can be configured to assist the collection equipment in realizing the spectral image collection.

In some embodiments, the light source assembly can be configured to illuminate the to-be-collected object. The illumination light of the light source assembly can include light with a wavelength sensitive to the to-be-collected object (e.g., the glue path and surrounding/substrate of the glue path). The multispectral camera/hyperspectral camera can be configured to perform the spectral image collection on the to-be-collected object illuminated by the light source assembly to obtain the first spectral image.

An incandescent lamp that can emit full-band light can be used as the light source assembly.

At 102, the spectral characteristics corresponding to different image regions in the first spectral image are determined.

The spectral characteristics corresponding to different image regions in the first spectral image can include spectral distribution characteristics corresponding to the sampling points of different image regions in the first spectral image.

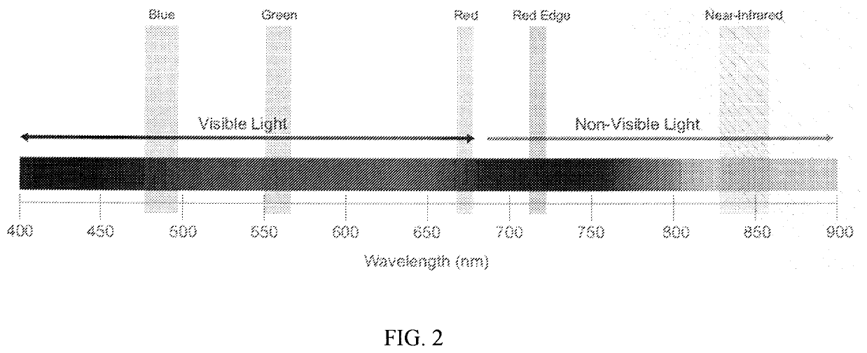

In the first spectral image of the to-be-collected object obtained by the multispectral/hyperspectral camera, the spectrum of each sampling point can include a series of channels, such as more than 100 color channels. FIG. 2 illustrates a schematic diagram of the colors of 5 channels (represented by different gray scales) of a series of channels included in a sampling point according to the present disclosure, which reflect the reflectance of the sampling point for the corresponding wavelength of the light.

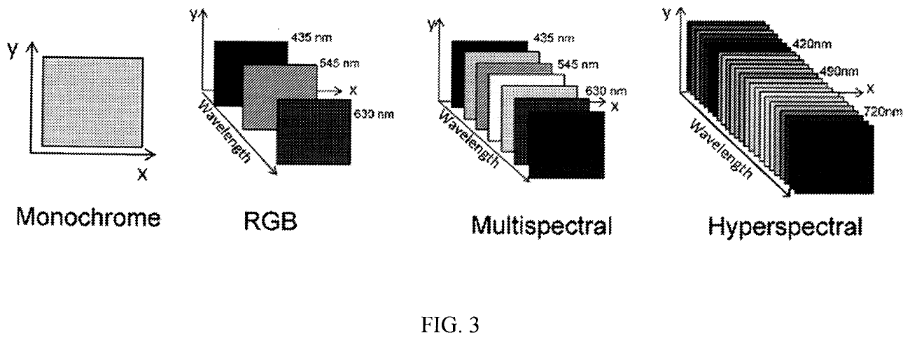

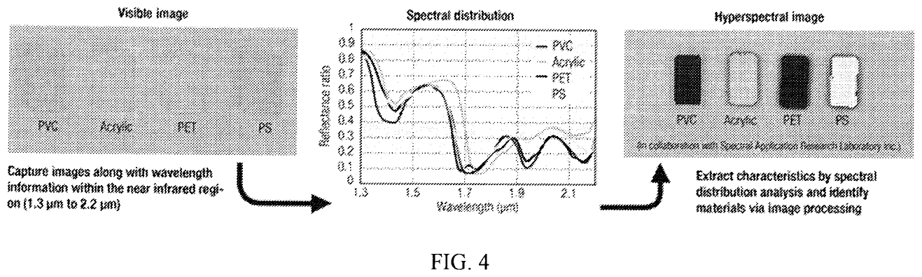

FIG. 3 illustrates a schematic diagram (different grayscales being used to represent different color channels) showing a comparison of different color channels corresponding to a grayscale image, an RGB (Red-Green-Blue) image, a multispectral image, and a hyperspectral image according to the present disclosure. Compared to the normal grayscale and RGB images, the spectral image (multispectral image/hyperspectral image) can have richer and more complex color channels and can more accurately represent the reflection of the captured object to different wavelengths of light. The applicant finds that objects with different materials can have different reflections to the different wavelengths of light, and objects with the same material of different densities and thicknesses can have different reflections to the different wavelengths of light. Thus, the spectral images of objects with different materials or the same material of different densities/thicknesses can have different spectral distribution characteristics. FIG. 4 shows reflectance curves of different materials to different wavelengths of light in the multispectral/hyperspectral. Different materials such as PVC, Acrylic, PET, and PS have different reflectance to different wavelengths of light. Correspondingly, different spectral distribution characteristics can be represented in the captured spectral image.

Therefore, for the first spectral image of the to-be-collected object, in embodiments of the present disclosure, the spectral information of sampling points in different image regions of the first spectral image can be extracted, e.g., values of color channels included in different sampling points. According to the spectral information of the sampling point, the reflectance of the sampling point to different wavelengths of light can be determined. The light distribution characteristic of the sampling point can be represented by the reflectance of the sampling point to the different wavelengths of light to obtain the spectral characteristics corresponding to different image regions of the first spectral image, which can be used as the basis for recognizing the detection object and the background object (e.g., point glue path and substrate/surrounding of the point glue path) of the detection object in the first spectral image.

At 103, according to the spectral characteristics corresponding to the different image regions, attribute parameters of the to-be-collected objects corresponding to the different image regions are recognized.

The attribute parameters can be parameters related to the material of the to-be-collected object, which include but are not limited to the material, density, and/or thickness of the to-be-collected object.

After determining the spectral characteristics corresponding to the different image regions of the first spectral image, in some embodiments, the attribute parameters such as the materials, densities, and/or thicknesses of the to-be-collected objects corresponding to the different image regions can be recognized according to the spectral characteristics corresponding to the different image regions of the first spectral image.

In some embodiments, the spectral distribution characteristics of the sampling points corresponding to the different image regions can be processed using the pre-trained first recognition model to obtain the attribute parameters of the to-be-collected objects corresponding to the different image regions.

In some embodiments, the first recognition model that is configured to extract the spectral characteristics of the different image regions of the first spectral image and recognize the attribute parameters of the different regions according to the extracted spectral characteristics can be pre-trained. For example, the detection object and the background object of the detection object can be the point glue path and the substrate/surrounding of the point glue path, respectively. A series of spectral images of the glue path and the material (the substrate/surrounding of the glue path) neighboring the glue path can be pre-collected. The attribute information such as the materials, densities, and/or thicknesses corresponding to the glue path and the material neighboring the glue path can be marked for each spectral image to obtain a series of spectral images marked with the attribute information of the glue path and the material neighboring the glue path, which can be used as the model training samples. Based on this, the training samples can be used to train network models such as convolutional neural networks (CNNs). Through the training process, the model can learn the spectral distribution characteristics of the different image regions of the sample image and the correlation embedded in the attribute information (the material, density, and/or thickness) of the spectral distribution characteristics. Thus, the trained model can extract the spectral distribution characteristics of the different regions of the spectral image. the attribute information such as the materials, densities, and/or thicknesses corresponding to the different regions can be recognized according to the spectral distribution characteristics of the different regions of the spectral image.

However, without being limited to the implementation based on the first recognition model, in some other embodiments, the attribute parameters of the to-be-collected objects corresponding to the different image regions can be recognized according to the spectral distribution characteristics of the sampling points corresponding to the different image regions of the first spectral image and the first recognition rule.

In some embodiments, the first recognition rule can be pre-established. The first recognition rule can include that each of the different attribute parameters corresponds to a reflectance range of each type of light of the different wavelengths of light, for example, the reflectance range of each type of light of the different wavelengths of light corresponding to different materials, and/or the reflectance range of each type of light of the different wavelengths of light corresponding to the different densities and thicknesses of the same material.

According to the spectral distribution characteristics of the sampling points corresponding to the different image regions of the first spectral image and the first recognition rule, when the attribute parameters of the to-be-collected objects corresponding to the different image regions are recognized, the reflectance of the sampling points corresponding to the different image regions of the first spectral image to each wavelength of light of the different wavelengths of light, and the reflectance range in the first recognition rule can be recognized. The attribute parameters corresponding to the actual reflectance ranges in the first recognition rule, such as the material and/or density and thickness, can be used as the attribute parameters of the to-be-collected objects corresponding to the different image regions.

At 104, according to the attribute parameters corresponding to the different image regions of the first spectral image, the target region corresponding to the detection object in the first spectral image is determined, and the second spectral image formed by the target region is obtained.

After recognizing the attribute parameters of the to-be-collected objects corresponding to the different image regions of the first spectral image, the target region corresponding to the detection object in the first spectral image can be determined according to the attribute parameters corresponding to the different image regions and in connection with the actual attribute parameters of the detection objects. For example, the target region of the point glue path in the first spectral image can be determined according to the materials of the to-be-collected objects corresponding to the different image regions in the first spectral image and the actual material of the point glue path.

Then, through the image segmentation, the second spectral image formed by the target region can be extracted from the first spectral image, i.e., the spectral image of the detection object such as the point glue path.

At 105, the abnormality detection is performed on the detection object based on the region characteristics of the different image regions of the second spectral image.

Finally, based on the region characteristics of the different image regions of the second spectral image, the abnormality detection can be performed on the detection object. For example, whether a point glue defect exists on the point glue path can be detected, and the defect type can be detected when the point glue defect exists.

The defect type of the point glue path can include but is not limited to glue breaks, glue overflow, residual glue from foreign matter, etc.

Based on the above solution, in the processing method of the present disclosure, the spectral image collection can be performed on the detection object and the to-be-collected object consistent of the background object of the detection object. According to the spectral characteristics of the different image regions of the collected first spectral image, the attribute parameters of the to-be-collected objects corresponding to the different image regions can be recognized. The recognized attribute parameters can be related to the materials of the to-be-collected objects. Then, according to the attribute parameters corresponding to the different image regions of the first spectral image, the second spectral image corresponding to the detection object can be positioned and extracted from the first spectral image. The abnormality detection can be performed on the detection object based on the region characteristics of the different image regions in the second spectral image. Thus, the present disclosure provides a solution for performing the abnormality detection on the detection object such as the point glue path based on the machine vision.

Moreover, in the present disclosure, the detection object and the background object of the detection object can be differentiated through the spectral characteristics. Compared to the existing solutions of performing the abnormality detection based on the data of the detection object such as the glue path collected by the 2D area camera or the laser profiler, the image part corresponding to the detection object can be more accurately and rapidly recognized without being impacted by the change of the detection object. The processing method of the present disclosure can have a strong adaptability for the different forms (e.g., glue path adjustment) of the detection objects with the same model or the situation with model and manufacturing line changeover. The problem of few samples can be overcome. The preparation time for model and manufacturing line changeover can be shortened to improve the accuracy rate and efficiency of performing the abnormality detection on the detection object.

When performing the abnormality detection on the detection object based on the region characteristics of different image regions in the second spectral image, in the implementation of the present disclosure, the abnormality detection can be performed on the detection object according to the visual characteristics of the different image regions of the second spectral image.

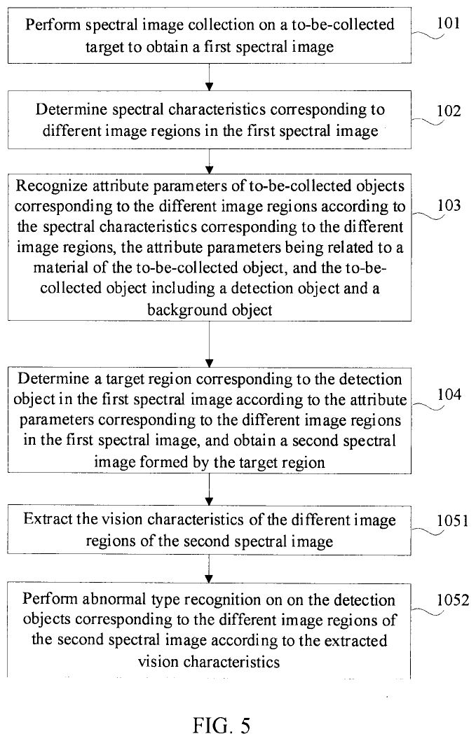

As shown in the schematic flowchart of the processing method in FIG. 5. In some embodiments, step 105 in the processing method of FIG. 1 further includes the following steps.

At 1051, the visual characteristics of the different image regions of the second spectral image are extracted.

In some embodiments, the present disclosure can include but is not limited to performing the edge detection and/or characteristic point extraction on the different image regions of the second spectral image based on the techniques such as the edge detection and/or the local characteristic points to recognize the edge characteristics and/or local characteristics of the different image regions of the second spectral image as the visual characteristics of the different image regions.

For example, the point glue path can be the second spectral image. The extracted visual characteristic can include but is not limited to the shape, orientation (e.g., regular straight line/folded line, and fixed orientation) of the edge line, the type and shape (e.g., various non-regular abnormal shapes) characteristics represented by the corresponding type point glue defect, and/or characteristics such as the convex (such as glue breaks), concave (such as residual glue from foreign matter, glue overflow), overflows (such as glue overflow) of the glue path that is more regular compared to the surrounding.

At 1052, the abnormal type recognition is performed on the detection objects corresponding to the different image regions of the second spectral image according to the extracted visual characteristics.

Then the extracted visual characteristics can be used as the recognition basis to perform the abnormality type recognition on the detection objects corresponding to the different image regions of the second spectral image.

In some embodiments, according to the extracted visual characteristics of the second spectral image and the second recognition rules, whether the abnormality exists in the detection object regions corresponding to the different image areas of the second spectral image can be recognized. When the abnormality exists, the corresponding abnormal type can be recognized.

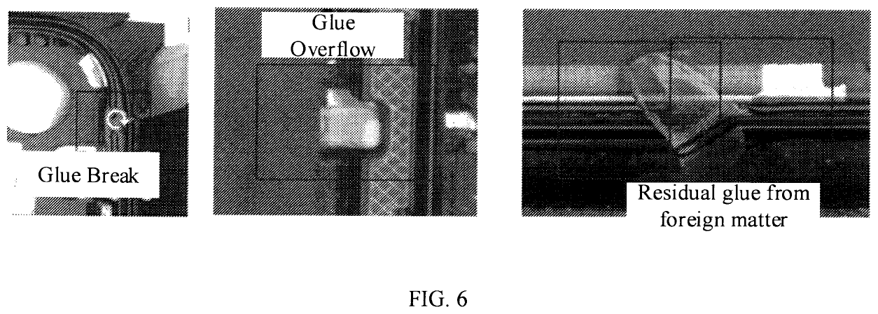

In some embodiments, the second recognition rule for performing the abnormality type recognition on the detection object can be pre-established. The second recognition rule can include reference visual characteristics corresponding to the different abnormality types of the detection objects, e.g., the reference visual characteristics corresponding to the different abnormality types such as the breaks, glue overflow, or residual glue from foreign matter of the point glue path. FIG. 6 illustrates physical diagrams of three types of glue path defects of glue breaks, glue overflow, and residual glue from foreign matter. In practical applications, in connection with the actual visual characteristics (preferably representative general characteristics presented by a sufficient amount of defect samples) represented by the different abnormality types of the detection object, the reference visual characteristics corresponding to the different abnormality types can be set in the second recognition rule.

In some other embodiments, the visual characteristics of the extracted second spectral image can be processed using the pre-trained second recognition model to obtain the abnormality recognition result. The abnormality recognition result can at least include the abnormality types when the detection object regions corresponding to the different image regions of the second spectral image are abnormal. In some embodiments, the abnormality recognition result can include the marked spectral image output by the second recognition model, in which the abnormal regions of the second spectral image are marked, and the abnormality types (e.g., breaks, overflow, or residual glue from foreign matter) are marked correlatively.

In some embodiments, the second recognition model can be pre-trained to extract visual characteristics from the second spectral image and perform the abnormality detection on the detection object based on the extracted visual characteristics. For example, when the detection object is the point glue path, a series of spectral images of abnormal and non-abnormal glue point paths can be obtained. The corresponding labels can be marked for each spectral image. For example, a label representing a “normal/abnormal glue path” can be marked in the spectral image for the normal point glue path. An abnormal region can be drawn in the spectral image of the abnormal point glue path. A specific abnormal type (e.g., glue breaks, glue overflow, or residual glue from foreign matter) can be marked for the abnormal region to obtain the series of glue path spectral images marked with the labeling information as the model training samples. Based on this, network models such as the CNN (convolutional neural networks) can be trained with the training samples. Through the training process, whether the corresponding regions and the visual characteristics of the different regions of the glue path in the model learning samples are abnormal can be continuously determined, and the correlation between the specific abnormal types and the abnormal situations can be determined. Thus, the trained model can extract the visual characteristics of the different regions of the second spectral image and recognize whether the corresponding region is abnormal and the abnormal type corresponding to the abnormal situation according to the extracted visual characteristics.

Then, by inputting the second spectral image into the second recognition model, the abnormality detection results output when the second recognition model performs the abnormality detection on the detection object based on the visual characteristics of different areas in the second spectral image can be obtained.

When performing the abnormality detection on the detection object based on the region characteristics of the different image regions in the second spectral image, another optional embodiment of the present disclosure can include performing the abnormality detection on the detection object according to the spectral characteristics of the different image regions in the second spectral image.

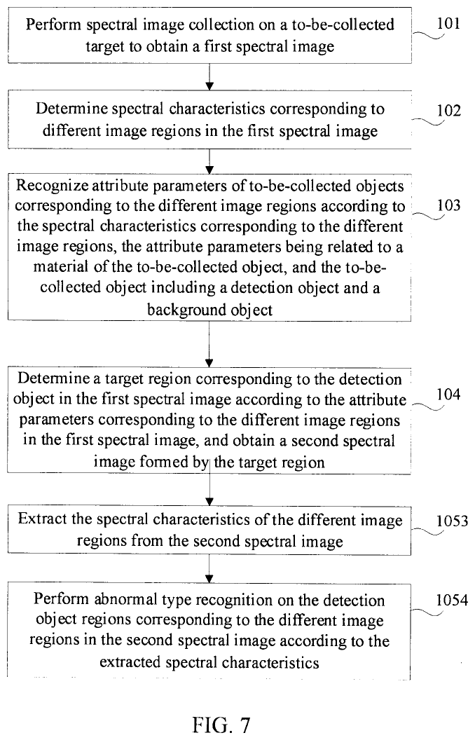

FIG. 7 shows a schematic flowchart of a processing method. In some embodiments, step 105 of the processing method in FIG. 1 includes the following processes.

At 1053, the spectral characteristics of the different image regions are extracted from the second spectral image.

The spectral characteristics of the different image regions in the second spectral image can include the spectral distribution characteristics corresponding to the sampling points of the different image regions in the second spectral image.

In some embodiments, the spectral information of sampling points in the different image regions of the second spectral image can be extracted, e.g., the color channel values included in different sampling points. According to the spectral information of the sampling points, the reflectance of the sampling points to the different wavelengths of light can be determined. The spectral distribution characteristics of the sampling point can be represented using the reflectance of the sampling point to the different wavelengths of light to obtain the spectral characteristics of the different image regions of the second spectral image.

At 1054, abnormal type recognition is performed on the detection object regions corresponding to the different image regions in the second spectral image according to the extracted spectral characteristics.

Then, the extracted spectral characteristics can be used as the basis for recognition to perform the abnormal type recognition on the detection object regions corresponding to the different image regions in the second spectral image to identify whether abnormalities exist in the different regions of the detection object and the specific abnormal types in the abnormal situation, such as the glue breaks, glue overflow, or residual glue from foreign matter.

Similar to the abnormality detection method based on the visual characteristics, when the abnormality detection is performed on the detection object based on the spectral characteristics, in some embodiments, according to the extracted spectral characteristics and the third recognition rule, whether the detection object regions corresponding to the different image regions in the second spectral image are abnormal can be determined, and the abnormal type corresponding to the abnormal situation can be determined.

In some embodiments, the third recognition rule for performing the abnormal type recognition on the detection object can be pre-established. The third recognition rule can include that the different abnormal types of the detection object correspond to reference spectral characteristics, respectively. In practical applications, according to the actual spectral characteristics presented by the different abnormal types of the detection object (preferably representative general characteristics presented by a sufficient amount of defect samples), the setting can be performed in the third recognition rule that the different abnormal types correspond to the reference spectral characteristics, respectively.

For example, when the detection object is a glue path, and the glue path defect is glue breaks, the material of the glue break region can be the material of the glue path substrate, which is different from the material of the normal glue path region. Thus, the glue break region and the normal glue path region can represent different spectral distribution characteristics in the second spectral image. When the glue path defect is glue overflow, as shown in FIG. 6, the glue material thickness of the glue overflow region is different from the glue material thickness of the normal glue path region. Correspondingly, the spectral characteristics of the glue overflow region and the normal glue path region can be different. When the glue path defect is the residual glue from foreign matter, the material of the defect region can be a mixed material of the glue material and the foreign matter. In connection with FIG. 6, in the situation, the spectral characteristics of the defect region and the normal glue path region are different. Different defect types can correspond to different spectral characteristics, respectively. Thus, the actual spectral characteristics can be represented according to different defect types of the glue path. The reference spectral characteristics corresponding to the different glue path defects can be set in the third recognition rule.

In some other embodiments, the extracted spectral characteristics of the second spectral image can be processed using the pre-trained third recognition model to obtain the abnormal recognition results. The abnormal recognition results can at least include the abnormal types of the detection object regions corresponding to the different image regions of the second spectral image in the abnormal situation. In some embodiments, the abnormal recognition result can include the marked spectral image output by the third recognition model marked with the abnormal regions of the second spectral image and the specific abnormal types correlated marked for the abnormal regions.

In some embodiments, the third recognition model for extracting the spectral characteristics from the second spectral image and performing the abnormality detection on the detection object based on the extracted spectral characteristics can be pre-trained. For example, the detection object can be the point glue path, and a series of spectral images of the abnormal and non-abnormal point glue paths can be pre-obtained. A corresponding label can be marked for each spectral image. For example, a label representing a “normal/abnormal glue path” can be marked in the spectral image for the normal point glue path. An abnormal region can be drawn in the spectral image of the abnormal point glue path. A specific abnormal type (e.g., glue breaks, glue overflow, or residual glue from foreign matter) can be marked for the abnormal region to obtain the series of glue path spectral images marked with the labeling information as the model training samples. Based on this, network models such as the CNN (convolutional neural networks) can be trained with the training samples. Through the training process, whether the corresponding regions and the visual characteristics of the different regions of the glue path in the model learning samples are abnormal can be continuously determined, and the correlation between the specific abnormal types and the abnormal situations can be determined. Thus, the trained model can extract the visual characteristics of the different regions of the second spectral image and recognize whether the corresponding region is abnormal and the abnormal type corresponding to the abnormal situation according to the extracted visual characteristics.

Then, by inputting the second spectral image into the third recognition model, the abnormality detection results output when the third recognition model performs the abnormality detection on the detection object based on the visual characteristics of different areas in the second spectral image can be obtained.

In summary, since the spectral characteristics differentiate different materials more easily, in the present disclosure, the detection object and the background object can be differentiated according to the spectral characteristics. Compared to the existing solutions of performing the abnormality detection based on the data of the detection object such as the glue path collected by the 2D area camera or the laser profiler. The image part corresponding to the detection object can be more accurately and rapidly recognized without being impacted by the change of the detection object. The processing method of the present disclosure can have a strong adaptability for the different forms (e.g., glue path adjustment) of the detection objects with the same model or the situation with model and manufacturing line changeover. The problem of few samples can be overcome. The preparation time for model and manufacturing line changeovers can be shortened to improve the accuracy rate and efficiency of performing the abnormality detection on the detection object.

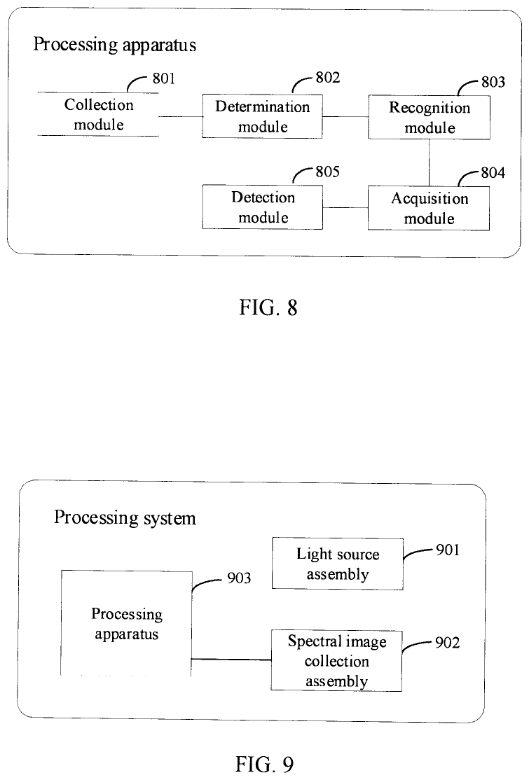

Corresponding to the above processing method, the present disclosure also provides a processing apparatus. As shown in FIG. 8, the structure of the apparatus includes:
a collection module 801 configured to perform spectral image collection on the to-be-collected object to obtain the first spectral image;
a determination module 802 configured to determine the spectral characteristics corresponding to the different image regions in the first spectral image;
a recognition module 803 configured to recognize the attribute parameters of the to-be-collected objects corresponding to the different image regions according to the spectral characteristics corresponding to the different image regions, the attribute parameters being related to the material of the to-be-collected object, and the to-be-collected object including the detection object and the background object;
an acquisition module 804 configured to determine the target region corresponding to the detection object in the first spectral image according to the attribute parameters corresponding to the different image regions of the first spectral image, respectively, and obtain the second spectral image formed by the target regions; and
a detection module 805 configured to perform the abnormality detection on the detection object based on the region characteristics of the different image regions of the second spectral image.

In some embodiments, the determination module 802 can be configured to:
extract the spectral information of the sampling points in different image regions of the first spectral image; and
determine the reflectance of the sampling points to the light of different wavelengths according to the spectral information of the sampling points to obtain the spectral distribution characteristics of the sampling points;
where the spectral distribution characteristics of the sampling points corresponding to the different image regions of the first spectral image are used as the spectral characteristics corresponding to the different image regions.

In some embodiments, the recognition module 803 can be configured to:
recognize the attribute parameters of the to-be-collected object corresponding to the different image regions according to the spectral distribution characteristics of the sampling points corresponding to the different image regions and the first recognition rule, the first recognition rule including the reflectance of each wavelength of light of the different wavelengths of light corresponding to the different attribute parameters; or
using the pre-trained first recognition model to process the spectral distribution characteristics of the sampling points corresponding to the different image regions to obtain the attribute parameters of the to-be-collected objects corresponding to the different image regions.

In some embodiments, when the second spectral image formed by the target region is obtained, the acquisition module 804 can be further configured to:
segment the image of the target region from the first spectral image to obtain the second spectral image.

In some embodiments, the detection module 805 can be configured to:
extract the visual characteristics of the different image regions in the second spectral image; and
perform the abnormal type recognition on the detection object regions corresponding to the different image regions in the second spectral image according to the extracted visual characteristics.

In some embodiments, when performing the abnormal type recognition on the detection object regions corresponding to the different image regions in the second spectral image according to the extracted visual characteristics, the detection module 85 can be configured to:
recognize whether the detection object regions corresponding to different image regions in the second spectral image are abnormal and the specific abnormal types corresponding to the abnormal situations according to the extracted visual characteristics and the second recognition rule, the second recognition rule including reference visual characteristics corresponding to the different abnormality types of the detection objects; or
using the pre-trained second recognition model to process the extracted visual characteristics to obtain the abnormality recognition result, the abnormality recognition result at least including the abnormal type when the detection object regions corresponding to the different image regions of the second spectral image are abnormal.

In some embodiments, the detection module 805 can be configured to:
extract the spectral characteristics of different image regions in the second spectral image; and
perform the abnormal type recognition on the detection object regions corresponding to the different image regions in the second spectral image according to the extracted spectral characteristics.

In some embodiments, when performing the abnormal type recognition on the detection object regions corresponding to the different image regions in the second spectral image according to the extracted spectral characteristics, the detection module 805 can be further configured to:
recognize whether the detection object regions corresponding to the different image regions in the second spectral image are abnormal and the abnormal types corresponding to the abnormal situations, the third recognition rule including the reference spectral characteristics corresponding to the different abnormal types of the detection object; or
using the pre-trained third recognition model to process the extract spectral characteristics to obtain the abnormality recognition result, the abnormality recognition result at least including the abnormal types when the detection object regions corresponding to the different image regions in the second spectral image are abnormal.

For the data processing apparatus of embodiments of the present disclosure, since the data processing apparatus corresponds to the processing method of method embodiments, the description is simple. The relevant and similar parts can be referred to the description of method embodiments, which are not described in detail.

In addition, embodiments of the present disclosure also provide a processing system. As shown in FIG. 9, the system includes a light source assembly 901, a spectral image collection assembly 902, and the processing apparatus 903 of the embodiment above.

The light source assembly 901 can be configured to illuminate the to-be-collected object. The illumination light of the light source assembly 901 can include light with a wavelength sensitive to the to-be-collected object (e.g., the glue path and the surroundings/substrate of the glue path). The to-be-collected object can include the detection object and the background object.

Preferably, an incandescent lamp capable of emitting full-spectrum light can be used as the light source assembly.

The spectral image collection assembly 902 can be configured to collect the first spectral image of the to-be-collected object. The spectral image collection assembly 902 can be but is not limited to the multispectral camera or the hyperspectral camera.

The processing apparatus 903 can be configured to realize the abnormality detection for the detection object by executing the processing method according to any one of the method embodiments above.

For the functions of the assemblies in the processing system and the processing process of the abnormality detection of the detection object through the coordination of the assemblies, reference can be made to the relevant description of the above method embodiments, which is not described in detail.

It should be noted that various embodiments of the present specification are described in a progressive manner. Each embodiment primarily describes the differences from other embodiments. Same and similar members can be referred to each other as embodiments of the present disclosure.

To facilitate description, when the system or apparatus is described, the system or apparatus can be divided into modules or units according to the functions for description. Of course, when the present disclosure is implemented, the functions of the units can be realized in one or more pieces of software and/or hardware.

Through the description of the above embodiments, those skilled in the art can clearly understand that the present disclosure can be implemented with the aid of software combined with necessary general hardware platforms. Based on such understanding, the technical solutions of the present disclosure, or the part contributing to the existing technology can be embodied in the form of a software product. The computer software product can be stored in a storage medium, such as ROM/RAM, magnetic disk, optical disk, etc., and include several instructions for enabling a computer device (which can be a personal computer, server, or network device, etc.) to execute the methods described in various embodiments or certain parts of embodiments of the present disclosure.

Finally, it should also be noted that in the present specification, relational terms such as first, second, third, and fourth are used solely to distinguish one entity or operation from another, and do not necessarily require or imply any actual relationship or order between these entities or operations. Moreover, terms such as “comprising,” “including,” or any variations thereof are intended to cover non-exclusive inclusions, so that a process, method, article, or device that includes a series of elements not only includes those elements but also includes other elements not explicitly listed or elements inherent to such process, method, article, or device. When there are no further limitations, elements defined by the phrase “comprising a . . . ” do not exclude the existence of additional identical element in the process, method, article, or device that includes the element.

The above are only some embodiments of the present disclosure. It should be noted that for those ordinary skills in the art, several improvements and modifications can be made without departing from the principles of the present disclosure. These improvements and modifications should also be considered within the scope of the present disclosure.

1. A processing method comprising:
performing spectral image collection on a to-be-collected target to obtain a first spectral image;
determining spectral characteristics corresponding to different image regions in the first spectral image;
recognizing attribute parameters of to-be-collected objects corresponding to the different image regions according to the spectral characteristics corresponding to the different image regions, the attribute parameters being related to a material of the to-be-collected object, and the to-be-collected object including a detection object and a background object;
determining a target region corresponding to the detection object in the first spectral image according to the attribute parameters corresponding to the different image regions in the first spectral image, and obtaining a second spectral image formed by the target region; and
performing abnormality detection on the detection object based on region characteristics of different image regions of in the second spectral image.

2. The method according to claim 1, wherein determining the spectral characteristics corresponding to the different image regions in the first spectral image includes:
extracting spectral information of sampling points of the different image regions in the first spectral image; and
determining reflectance of the sampling points for different wavelengths of light based on the spectral information to obtain spectral distribution characteristics of the sampling points;
wherein the spectral distribution characteristics of the sampling points corresponding to the different image regions in the first spectral image are used as the spectral characteristics of the different image regions.

3. The method according to claim 2, wherein recognizing the attribute parameters of the to-be-collected objects corresponding to the different image regions according to the spectral characteristics corresponding to the different image regions includes:
recognizing the attribute parameters of the to-be-collected objects corresponding to the different image regions according to the spectral distribution characteristics of the sampling points corresponding to the different image regions and a first recognition rule, wherein the first recognition rule includes reflectance ranges for each wavelength of light of different wavelengths of the light corresponding to the different attribute parameters; or
processing the spectral distribution characteristics of the sampling points corresponding to the different image regions using a pre-trained first recognition model to obtain the attribute parameters of the to-be-collected objects corresponding to the different image regions.

4. The method according to claim 1, wherein obtaining the second spectral image formed by the target image region includes:
segmenting an image of the target region from the first spectral image to obtain the second spectral image.

5. The method according to claim 1, wherein performing abnormality detection on the detection object based on the region characteristics of the different image regions in the second spectral image includes:
extracting visual characteristics of the different image regions in the second spectral image; and
performing abnormal type recognition on detection object regions corresponding to the different image regions in the second spectral image according to the extracted visual characteristics.

6. The method according to claim 5, wherein performing the abnormal type recognition on the detection object regions corresponding to the different image regions in the second spectral image according to the extracted visual characteristics includes:
recognizing whether the detection object regions corresponding to the different image regions in the second spectral image are abnormal and an abnormal type corresponding to an abnormal situation according to the extracted visual characteristics and a second recognition rule, wherein the second recognition rule includes reference visual characteristics corresponding to different abnormal types of the detection object; or
processing the extracted visual characteristics using a pre-trained second recognition model to obtain an abnormality recognition result, wherein the abnormality recognition result at least includes the abnormal type when the detection object regions corresponding to the different image regions are abnormal in the second spectral image.

7. The method according to claim 1, wherein performing the abnormality detection on the detection object based on the region characteristics of the different image regions in the second spectral image includes:
extracting the spectral characteristics of the different image regions in the second spectral image; and
performing the abnormal type recognition on the detection object regions corresponding to the different image regions in the second spectral image according to the extracted spectral characteristics.

8. The method according to claim 7, wherein performing the abnormal type recognition on the detection object regions corresponding to the different image regions in the second spectral image according to the extracted spectral characteristics includes:
identifying whether the detection object regions corresponding to the different image regions in the second spectral image are abnormal and the abnormal type corresponding to an abnormal situation according to the extracted spectral characteristics and a third recognition rule, wherein the third recognition rule includes reference spectral characteristics corresponding to different abnormal types of the detection object; or
processing the extracted spectral characteristics using a pre-trained third recognition model to obtain an abnormal recognition result, wherein the abnormal recognition result at least includes an abnormal type when the detection object regions corresponding to the different image regions in the second spectral image.

9. A processing apparatus comprising:
a collection module configured to perform spectral image collection on a to-be-collected target to obtain a first spectral image;
a determination module configured to determine spectral characteristics corresponding to different image regions in the first spectral image;
a recognition module configured to recognize attribute parameters of to-be-collected objects corresponding to the different image regions according to the spectral characteristics corresponding to the different image regions, the attribute parameters being related to a material of the to-be-collected object, and the to-be-collected object including a detection object and a background object;
an acquisition module configured to determine a target region corresponding to the detection object in the first spectral image according to the attribute parameters corresponding to the different image regions in the first spectral image, and obtain a second spectral image formed by the target region; and
a detection module configured to perform abnormality detection on the detection object based on region characteristics of different image regions of in the second spectral image.

10. A processing system comprising:
a light source assembly configured to illuminate a to-be-collected object, wherein the to-be-collected object includes a detection object and a background object;
a spectral image collection assembly configured to collect a first spectral image of the to-be-collected object; and
a processing device configured to:
perform spectral image collection on a to-be-collected target to obtain a first spectral image;
determine spectral characteristics corresponding to different image regions in the first spectral image;
recognize attribute parameters of to-be-collected objects corresponding to the different image regions according to the spectral characteristics corresponding to the different image regions, the attribute parameters being related to a material of the to-be-collected object, and the to-be-collected object including a detection object and a background object;
determine a target region corresponding to the detection object in the first spectral image according to the attribute parameters corresponding to the different image regions in the first spectral image, and obtaining a second spectral image formed by the target region; and
perform abnormality detection on the detection object based on region characteristics of different image regions of in the second spectral image.

11. The processing system according to claim 10, wherein the processing device is further configured to:
extract spectral information of sampling points of the different image regions in the first spectral image; and
determine reflectance of the sampling points for different wavelengths of light based on the spectral information to obtain spectral distribution characteristics of the sampling points;
wherein the spectral distribution characteristics of the sampling points corresponding to the different image regions in the first spectral image are used as the spectral characteristics of the different image regions.

12. The processing system according to claim 11, wherein the processing device is further configured to:
recognize the attribute parameters of the to-be-collected objects corresponding to the different image regions according to the spectral distribution characteristics of the sampling points corresponding to the different image regions and a first recognition rule, wherein the first recognition rule includes reflectance ranges for each wavelength of light of different wavelengths of the light corresponding to the different attribute parameters; or
process the spectral distribution characteristics of the sampling points corresponding to the different image regions using a pre-trained first recognition model to obtain the attribute parameters of the to-be-collected objects corresponding to the different image regions.

13. The processing system according to claim 10, wherein the processing device is further configured to:
segment an image of the target region from the first spectral image to obtain the second spectral image.

14. The processing system according to claim 10, wherein the processing device is further configured to:
extract visual characteristics of the different image regions in the second spectral image; and
perform abnormal type recognition on detection object regions corresponding to the different image regions in the second spectral image according to the extracted visual characteristics.

15. The processing system according to claim 14, wherein the processing device is further configured to:
recognize whether the detection object regions corresponding to the different image regions in the second spectral image are abnormal and an abnormal type corresponding to an abnormal situation according to the extracted visual characteristics and a second recognition rule, wherein the second recognition rule includes reference visual characteristics corresponding to different abnormal types of the detection object; or
process the extracted visual characteristics using a pre-trained second recognition model to obtain an abnormality recognition result, wherein the abnormality recognition result at least includes the abnormal type when the detection object regions corresponding to the different image regions are abnormal in the second spectral image.

16. The processing system according to claim 10, wherein the processing device is further configured to:
extract the spectral characteristics of the different image regions in the second spectral image; and
perform the abnormal type recognition on the detection object regions corresponding to the different image regions in the second spectral image according to the extracted spectral characteristics.

17. The processing system according to claim 16, wherein the processing device is further configured to:
identify whether the detection object regions corresponding to the different image regions in the second spectral image are abnormal and the abnormal type corresponding to an abnormal situation according to the extracted spectral characteristics and a third recognition rule, wherein the third recognition rule includes reference spectral characteristics corresponding to different abnormal types of the detection object; or
process the extracted spectral characteristics using a pre-trained third recognition model to obtain an abnormal recognition result, wherein the abnormal recognition result at least includes an abnormal type when the detection object regions corresponding to the different image regions in the second spectral image.
